(19) United States
(12) Patent Application Publication
(10) Pub. No.: US 2008/0007135 A1
(43) Pub. Date: Jan. 10, 2008

(54) Carbon brush holder for motor

(75) Inventors: Ke-Hsien Li, Taichung City (TW); Meng-Chiu Yu, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Taiwan Long Hawn Enterprise Co., Taichung City (TW)

(21) Appl. No.: 11/481,857

(22) Filed: Jul. 7, 2006

(51) Int. Cl. H01R 39/38

(52) U.S. Cl. 310/239

(57) ABSTRACT

A carbon brush holder for use in a motor includes a holder body and a constant force spring rack. The holder body has a carbon brush accommodation hole for accommodating a carbon brush therein and two receiving holes in communication with the carbon brush accommodation hole. The a constant force spring rack has a base panel affixed to an end face of the holder body with screws and two parallel support arms extending from the base panel and inserted into the receiving holes of the holder body for supporting a constant force spring member to keep the constant force spring member in contact with the carbon brush that is accommodated in the carbon brush accommodation hole such that carbon brush can be kept in close contact with a rotor conduction copper ring of a motor.

### BACKGROUND OF THE INVENTION

1. Field of the Invention

The present invention relates to motor parts and more specifically, to a carbon brush holder for use in a motor. The present invention relates also to a carbon brush assembly containing the carbon brush holder and a carbon brush supported in the carbon brush holder by a constant force spring member.

2. Description of the Related Art

FIG. 1 shows a commercialized carbon brush holder 1 for a motor. The carbon brush holder 1 comprises a holder body 2 and a constant force spring rack 3 for holding a constant force spring member 4. The holder body 2 has a front side, a back side, a carbon brush accommodation chamber 5 through the front and back sides, and a locating hole formed in one sidewall of the carbon brush accommodation chamber 5. The constant force spring rack 3 is stamped from a metal plate, having a first section 6 and a second section 7 perpendicular to the first section 6. The constant force spring member 4 has one end affixed to the first section 6.

When the aforesaid carbon brush holder 1 is in use, it is fixedly mounted inside the housing of the motor corresponding to the rotor conduction copper ring 8 of the motor. After installation of the carbon brush holder 1 in the housing of the motor, the front side of the carbon brush holder 1 faces the copper ring 8. After insertion of a carbon brush 9 into the carbon brush accommodation hole 5, the first section 6 of the constant force spring rack 3 is hooked on the inside wall of the location hole inside the carbon brush accommodation hole 5, thereby holding the constant force spring member 4 in the locating hole and the carbon brush accommodation chamber 5 in such a position that the constant force spring member 4 imparts a pressure to the carbon brush 9 against the copper ring 8. Thus, the carbon brush 9 contacts the copper ring 8.

The aforesaid carbon brush holder is still not satisfactory in function due to the following disadvantages:

1. When the user is installing the constant force spring rack 3 in the holder body 2, the operator must hold the second section 7 of the constant force spring rack 3 with the hand and then insert the first section 6 from the rear side of the holder body 2 into the carbon brush accommodation chamber 5 to force the first section 6 of the constant force spring rack 3 into engagement with a part of the inside wall of the locating hole inside the carbon brush accommodation chamber 5. Because the carbon brush 9 occupies the major space of the carbon brush accommodation chamber 5, it is quite difficult to insert the first section 6 of the constant force spring rack 3 into the narrow gap between the carbon brush 9 and the peripheral wall of the locating hole and to force the first section 6 into engagement with a part of the inside wall of the locating hole. During installation of the constant force spring rack 3, the operator cannot visually check the positioning status of the first section 6 in the locating hole. Because the operator cannot accurately see the installation of the first section 6 in the locating hole, the installation of the carbon brush holder is complicated.

2. After installation of the holder body 2 in the motor, there is only a small gap left between the front side of the holder body 2 and the rotor conduction copper ring 8 of the motor so that the carbon 9 can be stably maintained in contact with the rotor conduction copper ring 8 during rotation of the rotor. In order to provide sufficient space for enabling the operator to install the constant force spring rack 3, the locating hole is made for enabling the constant force rack 3 to be hooked on the inside wall of the locating hole at a locating that is spaced from the front side at a predetermined distance. Thus, the initial position of the constant force spring member 4 is far from the rotor conduction copper ring 8 so that when the carbon brush 9 in the carbon brush accommodation chamber 5 is pushed by the constant force spring member 4 to the wear-limit position, i.e. the upper dead point, as shown in FIG. 2, a sizeable carbon brush 9 is left, i.e., this design of carbon brush holder 1 does not enable the carbon brush 9 to be fully utilized.

### SUMMARY OF THE INVENTION

The present invention has been accomplished under the circumstances in view. It is therefore the one objective of the present invention to provide a carbon brush holder, which is easy to assembly and convenient in replacing the carbon brush.

It is another objective of the present invention to provide a carbon brush holder, which enables the installed carbon brush to be effectively used.

To achieve these objectives of the present invention, the carbon brush holder, which is used in a motor for holding a carbon brush with a constant force spring member therein, comprises a holder body and a constant force spring rack. The holder body has a first end face, a second end face opposite to the first end face, a carbon brush accommodation hole through the first end face and the second end face for accommodating a carbon brush therein, and two receiving holes arranged in parallel to and disposed in communication with the carbon brush accommodation hole at two opposite lateral sides of the carbon brush accommodation hole. The constant force spring rack has a base panel attached to the first end face of the holder body, and two support arms respectively extending from one side of the base panel in parallel and being respectively inserted into the two receiving holes of the holder body for supporting a constant force spring member to keep the constant force spring member in contact with the carbon brush that is accommodated in the carbon brush accommodation hole such that the carbon brush can be kept in close contact with a rotor conduction copper ring of the motor.

In a preferred embodiment of the present invention, the constant force spring member has two end portions respectively supported at the two support arms of the constant force spring rack, and a middle portion pressed on the carbon brush.

### BRIEF DESCRIPTION OF THE DRAWINGS

FIG. 1 is schematic drawing showing a status of use of a carbon brush holder according to the prior art.

FIG. 2 is a schematic drawing showing another status of use of the carbon brush holder according to the prior art.

FIG. 3 is an exploded view of a carbon brush holder according to a preferred embodiment of the present invention.

FIG. 4 is a schematic drawing showing a status of use of the carbon brush holder according to the preferred embodiment of the present invention.

FIG. 5 is a schematic drawing showing another status of use of the carbon brush holder according to the preferred embodiment of the present invention.

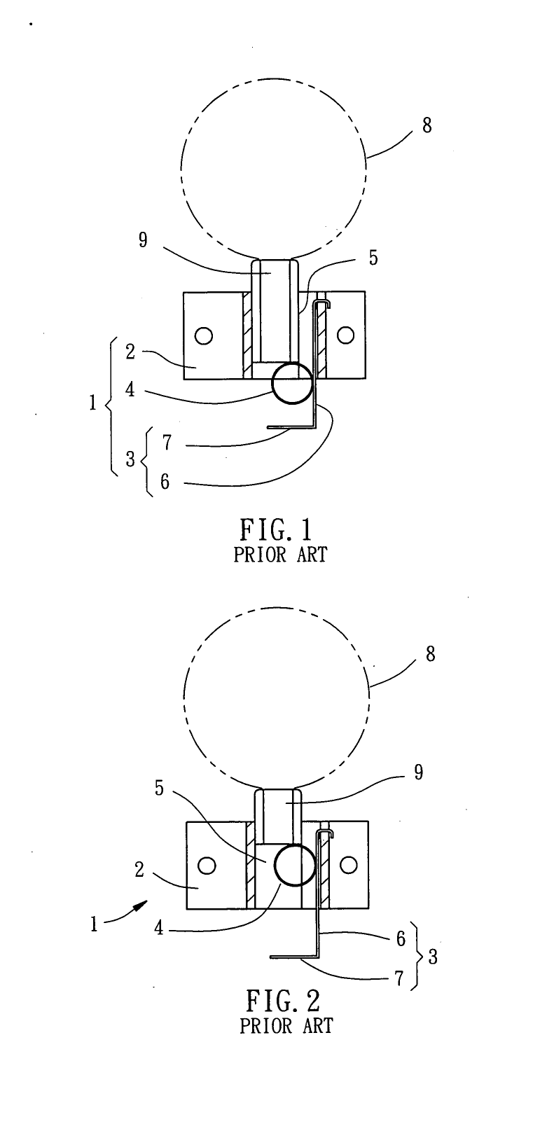

### DETAILED DESCRIPTION OF THE INVENTION

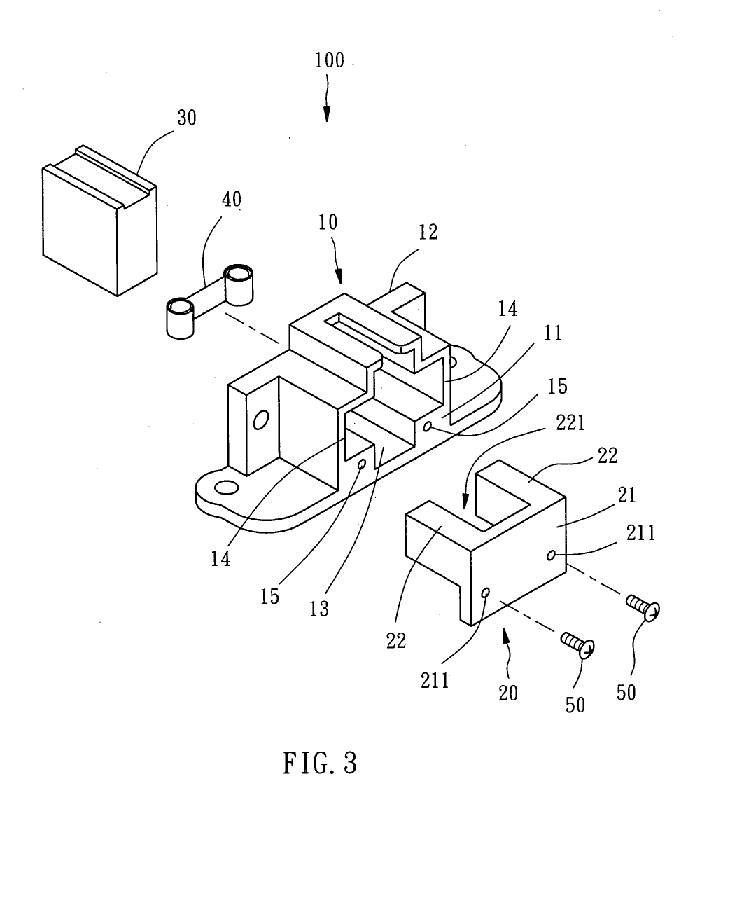

As shown in FIG. 3, a carbon brush holder 100 for use in a motor in accordance with a preferred embodiment of the present invention comprises a holder body 10 and a constant force spring rack 20.

The holder body 10 is integrally molded from a heat resistant and high hardness plastic material, having a first end face 11, a second end face 12 opposite to the first end face 11, a carbon brush accommodation hole 13 through the first end face 11 and the second end face 12, two receiving holes 14 arranged in parallel to and disposed in communication with the carbon brush accommodation hole 13 at two opposite lateral sides and extending to the first end face 11, and two screw holes 15 formed on the first end face 11 at two sides of the carbon brush accommodation hole 13.

The constant force spring rack 20 is integrally molded from a heat resistant and high hardness plastic material, having a base panel 21 and two support arms 22. The base panel 21 is a flat plate member having two through holes 211 corresponding to the two screw holes 15 of the holder body 10. The support arms 22 are respectively extended from one side of the base panel 21 and arranged in parallel, defining therebetween a receiving space 221.

After understanding of the structure of the parts of the carbon brush holder 100, the installation and use of the carbon brush holder 100 are described hereinafter.

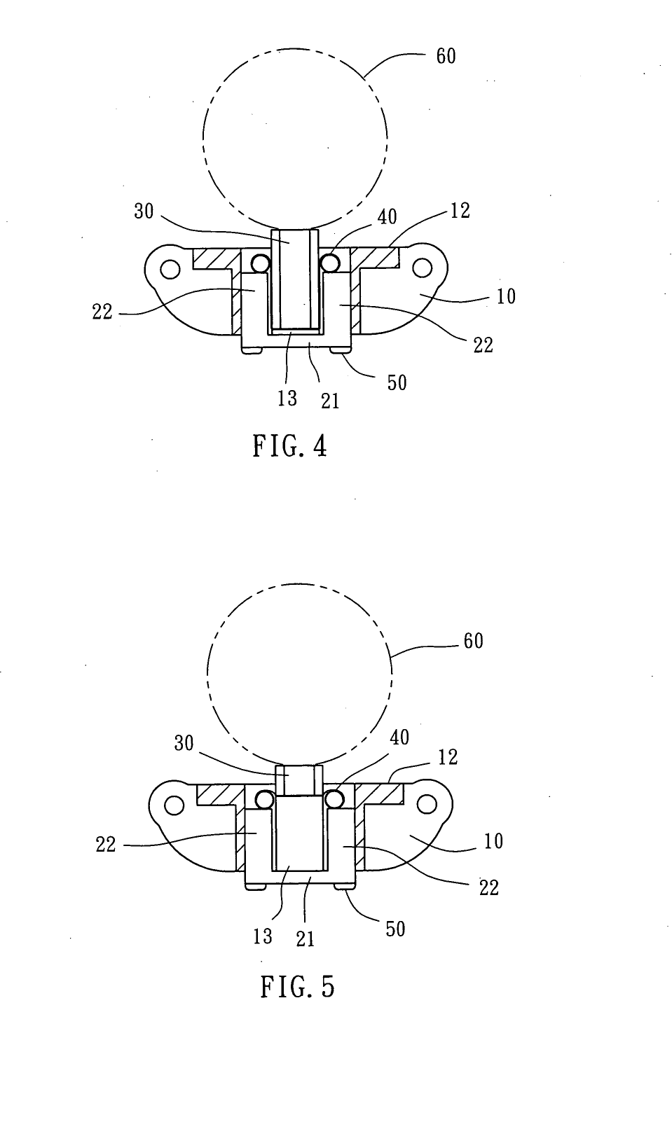

At first, the holder body 10 of the carbon brush holder 100 is affixed to the housing of the motor (not shown), and then the selected carbon brush 30 is inserted into the carbon brush accommodation hole 13, and then, a constant force spring member 40 is inserted into the carbon brush accommodation hole 13 and the receiving holes 14, and then the two support arms 22 of the constant force spring rack 20 are respectively inserted from the first end face 11 of the holder body 10 into the receiving holes 14 to keep the base panel 21 in close contact with the first end face 11 of the holder body 10 and the two through holes 211 in alignment with the two screw holes 15 respectively, and then two screws 50 are respectively inserted through the two through holes 211 and threaded into the screw holes 15 to lock the constant force spring rack 20 to the holder body 10. Thus, as shown in FIG. 4, the two end portions of the constant force spring member 40 are respectively stopped against the end edges of the two support arms 22 of the constant force spring rack 20, and the middle portion of the constant force spring member 40 is pressed on the carbon brush 30, keeping the carbon brush 30 in contact with the rotor conduction copper ring 60 of the motor constantly.

Because the installation of the carbon brush 30 does not use the space between the second end face 12 and the rotor conduction copper ring 60, it is not necessary to keep a great pitch between the second end face 12 and the rotor conduction copper ring 60. Therefore, the holder body 10 supports the carbon brush 30 in contact with the rotor conduction copper ring 40 steadily, preventing vibration of the carbon brush 30 during rotation of the rotor of the motor and reducing the chance of the presence of sparks between the carbon brush 30 and the rotor conduction copper ring 60.

Further, because the joining area between the constant force spring rack 20 and the holder body 10 is at the first end face 11 of the holder body 10, the user can visually check the installation of the constant force spring rack 20. Therefore, the installation of the constant force spring rack 20 is simple and convenient.

Further, the design of the constant force spring rack 20 allows installation of the constant force spring member 40 in the holder body 10 at a location close to the rotor conduction copper ring 60 to effectively push the carbon brush 30 to a better wear limit position, as shown in FIG. 5.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A carbon brush holder for use in a motor and for holding a carbon brush with a constant force spring member therein, the carbon brush holder comprising:
a holder body having a first end face, a second end face opposite to the first end face, a carbon brush accommodation hole through the first end face and the second end face for accommodating a carbon brush therein, and two receiving holes arranged in parallel to and disposed in communication with the carbon brush accommodation hole at two opposite lateral sides of the carbon brush accommodation hole; and
a constant force spring rack having a base panel attached to the first end face of the holder body, and two support arms respectively extending from one side of the base panel in parallel and being respectively inserted into the two receiving holes of the holder body for supporting a constant force spring member to keep the constant force spring member in contact with the carbon brush that is accommodated in the carbon brush accommodation hole.

2. The carbon brush holder as claimed in claim 1, wherein the base panel of the constant spring rack is firmly attached to the first end face of the holder body by at least one screw.

3. The carbon brush holder as claimed in claim 1, wherein the holder body is integrally molded from a heat resistant and high hardness plastic material.

4. The carbon brush holder as claimed in claim 1, wherein the two support arms of the constant force spring rack are respectively inserted into the two receiving holes of the holder body for supporting two end portions of the constant force spring member to keep a middle portion of the constant force spring member in contact with the carbon brush that is accommodated in the carbon brush accommodation hole.

5. A carbon brush assembly for use in a motor, the carbon brush assembly comprising:
a carbon brush holder comprising:
a holder body having a first end face, a second end face opposite to the first end face, a carbon brush accommodation hole through the first end face and the second end face, and two receiving holes in communication with the carbon brush accommodation hole; and
a constant force spring rack having a base panel attached to the first end face of the holder body, and two support arms respectively spacedly extending from one side of the base panel and being respectively inserted into the two receiving holes of the holder body;
a carbon brush received in the carbon brush accommodation hole of the holder body; and
a constant force spring member having two end portions respectively stopped at the two support arms of the constant force spring rack, and a middle portion pressed on the carbon brush.
